(19) United States
(12) Patent Application Publication
(10) Pub. No.: US 2014/0023227 A1
(43) Pub. Date: Jan. 23, 2014

(54) BROKEN MAG TICKET AUTHENTICATOR

(71) Applicant: Cubic Corporation, San Diego, CA (US)

(72) Inventor: Gavin R. Smith, Crawley (GB)

(21) Appl. No.: 13/943,645

(22) Filed: Jul. 16, 2013

Related U.S. Application Data
(60) Provisional application No. 61/672,699, filed on Jul. 17, 2012.

(51) Int. Cl. G06K 9/18

(52) U.S. Cl. CPC G06K 9/18
USPC 382/100

(57) ABSTRACT

A method for determining a status of transit media where the method includes imaging transit media with an optical imager to create a digital image of one or more surfaces of transit media. The method includes generating optical data from the digital image. Optical data includes information indicative of a transit product or usage. The method includes obtaining magnetic data from a magnetic strip of transit media with a magnetic media reader. Magnetic data includes information indicative of the transit product or usage encoded within the magnetic strip. Some embodiments include comparing, using a processing unit, optical data with magnetic data to determine whether optical data corresponds with magnetic data. The method can involve implementing one or more business rules from a database of business rules. This implementation can be based on the comparison. The method includes determining a status of transit media based on the implementation of business rules.

### CROSS-REFERENCES TO RELATED APPLICATIONS

This application claims the benefit of and is a non-provisional of U.S. Provisional Application Ser. No. 61/672,699 filed on Jul. 17, 2012 which is assigned to the assigner hereof and hereby expressly incorporated by reference in its entirety for all purposes.

### BACKGROUND OF THE INVENTION

This disclosure relates in general to authenticating information on transit media having magnetic strips on which encoded information is stored.

There are many industries that utilize magnetic media to provide access to services, such as transit systems. Additionally, magnetic media may be used for payment for goods or services. Many rejections at automated gatelines occur because the magnetic encoding on an access media had been performed poorly. Rejections may also be caused by the magnetic encoding being wiped by a magnet kept near the media, such as when in close proximity to magnetic phone cases. Helping passengers resolve these problems is time consuming for staff and often results in either wrongly assuming the media is fraudulent or by allowing the passenger to travel without checking the magnetic strip, which promotes fraud.

Existing magnetic media readers rely on the magnetic strip to provide the media details.

### BRIEF SUMMARY OF THE INVENTION

Embodiments of the invention, therefore, provide improved systems and methods for authenticating information on transit media having magnetic strips on which encoded information is stored. Merely by way of example, one embodiment provides a method for determining a status of a transit media. In certain embodiments, the method can include imaging a transit media with an optical imager to create a digital image of one or more surfaces of the transit media. Some embodiments include generating optical data from the digital image. The optical data comprises information indicative of a transit product or usage. The method may further include obtaining magnetic data from a magnetic strip of the transit media with a magnetic media reader. In some embodiments, the magnetic data can include information indicative of the transit product or usage encoded within the magnetic strip. In particular embodiments, the method may include using a processing unit to compare the optical data with the magnetic data to determine whether the optical data corresponds with the magnetic data. The method may also involve implementing one or more business rules from a database of business rules. In particular embodiments, the implementation may be based on the comparison. The method may further include determining a status of the transit media based on the implementation of the business rules.

In some embodiments, the method may include comparing either or both of the optical data or the magnetic data to known media types stored in a database to verify that either or both of the optical data or the magnetic data correspond to the known media types. Optionally, the method may include executing one or more image processing functions on the digital image. In one embodiment, the optical data can include printed text on one or more surfaces of the transit media that is identified with optical character recognition. In some embodiments, the status of the transit media may be at least one of the following: valid, poorly encoded, magnetically damaged, physically damaged, or fraudulently created. The method may also include determining a course of action based on the status of the transit media. In some embodiments, the course of action may include at least one of the following: confiscating the transit media, reissuing the transit media, or returning the transit media. In another embodiment, the method can include confiscating a fraudulently created transit media using a feeder communicatively coupled with the processor and storing a date of the confiscation and information associated with the confiscation in a database. In some embodiments, the comparison comprises a degree that the optical data and the magnetic data correspond. In another embodiment, the method further comprises identifying missing optical data or magnetic data, and wherein a placeholder is inserted to mark the missing optical data or missing magnetic data.

Another set of embodiments provides systems for determining a status of a transit media. In certain embodiments, an optical imager is configured to receive a transit media and produce a digital image of one or more surfaces of the transit media. In some cases, a magnetic media reader configured to obtain magnetic data from a magnetic strip of the transit media to identify information encoded within the magnetic strip. The magnetic data may include details relating to a transaction history or transit history of the transit media within a transit system details relating to a transaction history or transit history of the transit media within a transit system. In certain embodiments a processing unit may be communicatively coupled with the optical imager and the magnetic media reader. The processing unit can be operable to identify printed text on the digital image. The processing unit may be further operable to compare the magnetic data and the printed text to determine whether information store in the magnetic data and the printed text correspond. In some cases, the processing unit may be operable to implement one or more business rules from a database of business rules based on a degree that the optical data and the magnetic data correspond to determine a status of the transit media. The processing unit may be further operable to determine a course of action based on the status of the transit media.

In some embodiments, the processing unit is further operable to execute one or more image processing functions on the digital image. In another embodiment, the processing unit is further operable to compare either or both of the printed text or the magnetic data with known media types stored in a database to verify that either or both of the printed text or the magnetic data correspond to the known media types. In one embodiment, the system further includes a feeder communicatively coupled to the processor, wherein the processor can send a command to the feeder to confiscate the transit media. In some cases, the processing unit is further operable to identify missing printed text or magnetic data, and insert a placeholder to mark the missing printed text or missing magnetic data.

Other embodiments provide computer programs embodied on one or more computer-readable media. Some such programs may be executable by computer systems to perform methods of the invention. For example, the computer program may include instruction executable by a computer to generate optical data from a digital image of one or more surfaces of a transit media. In some cases, the optical data can include information that identifies details relating to a transaction history or transit history of the transit media within a transit system. In some embodiments, the computer program may include instructions to compare the optical data with magnetic data that is encoded on a magnetic strip of the transit media to determine whether the optical data corresponds with the magnetic data. In some embodiments, the computer program may include instructions to implement one or more business rules based on the comparison of the optical data and the magnetic data to determine a status of the transit media. In one embodiment, the instructions can be executed to determine a course of action based on the status of the transit media.

In some embodiments, the computer program further comprises instructions to execute one or more image processing functions on the digital image. In some cases, the computer program further comprises instructions executable by a computer to compare either or both of the optical data or the magnetic data with known media types stored in a database to verify that either or both of the optical data or the magnetic data correspond to the known media types. One embodiment provides that the computer program further comprises instructions executable by a computer to identify missing optical data or magnetic data, and insert a placeholder to mark the missing optical data or missing magnetic data. In one embodiment, the computer program further includes instructions executable by a computer to initiate a confiscation request for a fraudulently created transit media and to store a date of the confiscation and information associated with the confiscation in a database.

A further understanding of the nature and advantages of the present invention may be realized by reference to the remaining portions of the specification and the drawings, wherein like reference numerals are used throughout the several drawings to refer to similar components. In some instances, a sublabel is associated with a reference numeral and is delimited by a hyphen to denote one of multiple similar components. When reference is made to a reference numeral without specification to an existing sublabel, it is intended to refer to all such multiple similar components.

### BRIEF DESCRIPTION OF THE DRAWINGS

For a more complete understanding of this invention, reference is now made to the following detailed description of the embodiments as illustrated in the accompanying drawing, in which like reference designations represent like features throughout the several views and wherein:

FIG. 1 shows one embodiment of a system for authenticating a magnetic strip media.

FIG. 2 shows the system of FIG. 1 configured to fit within a bay of a media vending machine according to some embodiments of the invention.

FIG. 3 illustrates a vending machine that incorporates the system of FIG. 1 according to one embodiment of the invention.

FIG. 4 depicts a hybrid hardware/process flow diagram of the functionality of one embodiment of a system for authenticating magnetic strip media.

FIG. 5 shows a process diagram for determining a course of action to take based on the authentication status of a media according to some embodiments of the invention.

FIG. 6 illustrates a decision tree for determining a status and course of action of a media according to one embodiment of the invention.

FIG. 7 is a block diagram of an embodiment of an authentication system communicatively coupled with a processing unit for executing system functions provided herein

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram.

Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processing unit(s) may perform the necessary tasks. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

By combining optical imagers and magnetic readers in a single authentication system, the authentication of magnetic strip media can be automated, streamlined for greater efficiency, and can provide greater intelligence and accuracy. Such automated handling of authentication of magnetic strip media is relevant wherever magnetic strip media are used for access control. While the present invention may be relevant to many applications and industries, for convenience the description of the present invention is primarily directed towards transit applications.

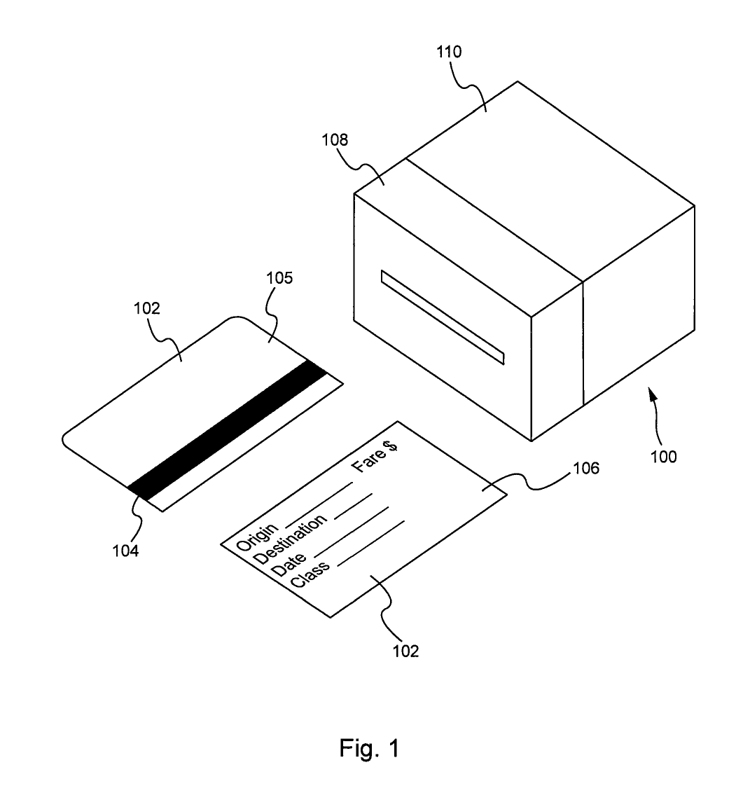

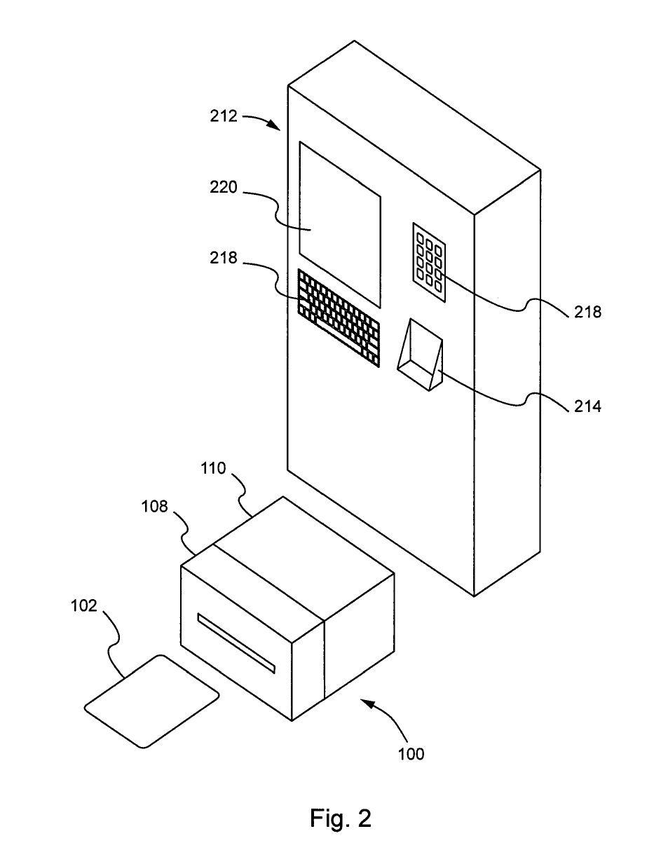

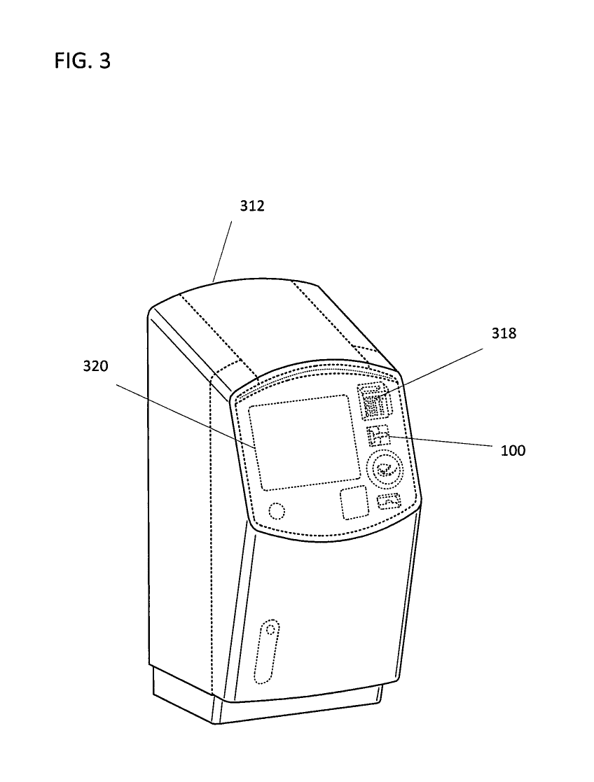

Referring first to FIG. 1, one embodiment of an authentication module 100 for authenticating a magnetic strip transit media 102 is shown. Media 102 can have one or more surfaces, such as faces and/or sides. For example media 102 may include a front face 106 and/or a back face 105. Authentication module 100 may be capable of automatically determining whether media 102 has been poorly encoded, magnetically and/or physically damaged, or fraudulently created. Media 102 may be physically damaged on one or both sides, which could leave some information readable and destroy or damage other information. Authentication module 100 may then determine a course of action regarding whether to remove, return, rewrite, and/or replace media 102. In some embodiments, authentication module 100 may be communicatively coupled with an attended ticket office (not shown). In these embodiments, the determined course of action may be sent to the attended ticket office where a clerk or other attendant may act in accordance with the course of action. Optionally, authentication module 100 may provide an override feature such that a clerk can act against the courses of action provided by authentication module 100 if, in the clerk's judgment, a different action is appropriate. Alternatively, authentication module 100 may be communicatively coupled to an unattended and/or automated media dispenser, such as a vending machine, as shown in FIGS. 2 and 3. In such a case, the course of action may be sent to a main processing control of the automated media dispenser and the media dispenser can automatically act according to the determination.

Authentication module 100 can receive a variety of transit media types including tickets, cards, passes, and the like. For example, media 102 may be a pass for a set period of access to a transit service, such as a monthly or yearly transit pass. Media 102 may also be valid for a specific number of uses, such as a ten-trip pass. Other media 102 may be configured for a single trip. Media 102 may be configured to operate only for a specific transit route, such as a single or multiple trips from Station A to Station B. In some embodiments, media 102 may be configured to operate as a one-way pass or for round trip transport. Media 102 may also specify a particular fare rate or travel class. In other embodiments, media 102 may be loaded up with funds that can be redeemed for transit. For example, a commuter may load media 102 with a set dollar amount and swipe or insert media 102 into a vending machine or other media dispensing location and be credited a particular trip that can be encoded onto media 102.

Media 102 can include front face 106, which may contain printed text. For example, the printed text may include information that is indicative of a transit product or usage, such as an origin of media 102, a beginning location of a trip, a final destination of the trip, a fare or class level associated with media 102, a price of media 102, and the like. In some embodiments back face 105 of media 102 or both sides of media 102 can include printed text. One or both sides of media 102 can also include a magnetic strip 104. Magnetic strip 104 is configured to store information indicative of a transit product or usage. For example, information encoded on magnetic strip 104 may include an origin of media 102, a beginning location of a trip, a final destination of the trip, a fare or class level associated with media 102, a price of media 102, and the like. In some embodiments the information may also include a period of validity associated with media 102, a monetary balance remaining on media 102, and/or a number of trips remaining on media 102

Authentication module 100 can utilize optical image scanning and character recognition in combination with magnetic data reading to compare information printed on media 102 with information encoded on magnetic strip 104 on media 102. In some embodiments, the information printed on media 102 is located on front face 106. Media 102 may be inserted into authentication module 100 by a person, such as a passenger or an attendant of a media dispensing location. Authentication module 100 can include an optical imager 108 and a magnetic media reader 110. Optical imager 108 is configured to generate an image of front face 106 and/or back face 105 of media 102. Optical imager 108 can be any device capable of producing an image or other representation of one or more surfaces of media 102, such as a camera, scanner, or the like. Optical imager 108 may be a pre-made, off the shelf unit incorporated into authentication module 100 or optical imager 108 can be specially fabricated for use within authentication module 100.

Magnetic media reader 110 is configured to read data that is encoded on magnetic strip 104 of media 102. Magnetic media reader 110 may be configured to rewrite and/or encode media. This rewrite feature allows magnetic media reader 110 to reissue media 102 that has been re-encoded, or optionally, to issue a newly encoded media 102. In some instances, magnetic media reader 110 may be further configured to read payment media. This allows authentication module 100 to handle monetary transactions for the purchase of new trips without needing a separate magnetic reader for the payment media. The combination of capabilities to encode magnetic media and to read payment media can enable authentication module 100 to issue newly purchased transit media without the necessity for additional physical components.

In some embodiments, optical imager 108 and magnetic media reader 110 can be configured such that the devices are within a single housing or make up a single unit. In such configurations, media 102 passes through the devices sequentially. In some embodiments media 102 can be read by optical imager 108 before passing through magnetic media reader 110, although this order may be reversed. In some embodiments, a feeder (not shown) configured to draw media 102 into optical imager 108 can be disabled. Magnetic media reader 110 can then be configured to have an extended feeder (not shown) that operates to draw media 102 through optical imager 108 and magnetic media reader 110. In other embodiments, optical imager 108 can be positioned beneath magnetic media reader 110 such that magnetic media reader 110 can draw in media 102, read the magnetic strip data, and push media 102 through optical imager 108.

Referring now to FIG. 2, authentication module 100 can be implemented as a standalone device or can be incorporated into a pre-existing unit 212, such as a vending machine or a video media office (VTO). Pre-existing unit 212 can include a display screen 220, a bay 214 for housing the authentication module 100, and one or more user interface portions 218. User interface portions 218 may include, for example, a keyboard, a numerical keypad, a touch screen, and/or a pointer device to allow customer interaction with authentication module 100. Display screen 220 can display an analysis of a media 102 that has been inserted into authentication module 100. The analysis may include a representation of data stored on media 102, as well as a status of any processes being run by authentication module 100, such as the issuance of a new media or a notice of confiscation. A notice of confiscation could include a message indicating how a customer could contest the confiscation.

Referring to FIG. 3, authentication module 100 positioned within a bay of a media vending machine 312 is illustrated. Vending machine 312 can include a display screen 320, an authentication module 100, and one or more user interface portions 318. User interface portions 318 may include, for example, a keyboard, a numerical keypad, a touch screen, and/or a pointer device to allow customer interaction with authentication module 100. The display screen 320 can display an analysis of a media 102 that has been inserted into authentication module 100. The analysis may include a representation of data stored on media 102, as well as a status of any processes being run by authentication module 100, such as the issuance of a new media or a notice of confiscation.

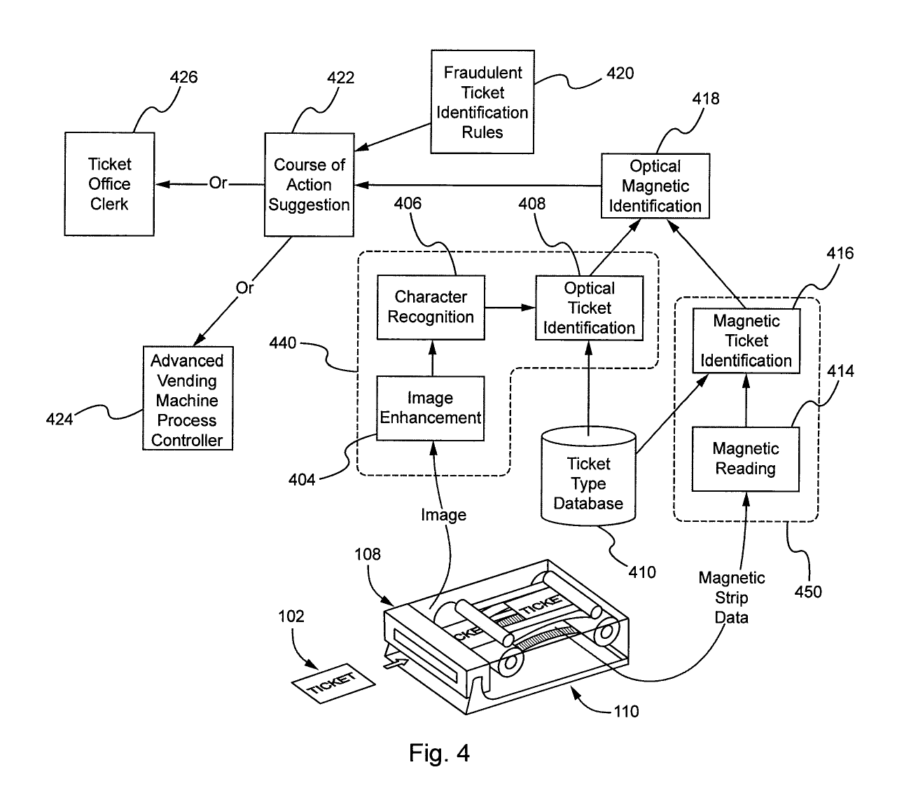

Referring to FIG. 4, a hybrid process and hardware flow chart for a media authentication module is shown. An authentication module such as those described in FIGS. 1-3 and 7 may be used to carry out the process described below in reference to FIG. 4. Optical imager 108 can be communicatively coupled to a processing unit and a memory (not shown). The processing unit can be configured to execute various software routines. After a media 102 is inserted into optical imager 108, it may be processed by an optical imaging routine 440. In one embodiment, the optical imaging routine can include a character recognition subroutine. The character recognition subroutine can identify text printed on media 102 at block 406. Such printed text may include, for example, an origin of media 102, a beginning location of a trip, a final destination of the trip, a fare or class level associated with media 102, a price of media 102, and the like. In some embodiments, the image can be processed by one or more image processing functions or subroutines at block 404 prior to performing character recognition at block 406. The image processing functions can include enhancement functions that can manipulate an image, including, but not limited to, adjusting the contrast or sharpening the image. The image processing functions can manipulate the image received from optical imager 108 to make it easier for character recognition to be performed at block 406.

Some embodiments can further include an optical media identification subroutine. The optical media identification subroutine can check the text read off the media against a database 410 of known media types and/or details at block 408. Details may include station locations, a period of validity for the media, and the like. Checking the identified text against database 410 allows the identified text to be verified against a list of possible media, providing an additional layer of security. Some embodiments may utilize a database of all individual media sold. The optical media identification subroutine can check the text against such a database. However, it is preferable to utilize database 410, which only stores possible media types and details in order to reduce the amount of storage space and/or the amount of time necessary to poll database 410 for matching entries. Some embodiments may utilize an identifier or code associated with a media type within database 410. For example, a media for a trip from Station A to Station B during off-peak hours may be represented by an identifier, such as a numerical, alphanumerical, or other code. This identifier may then be sent to a comparison subroutine. In embodiments that do not utilize an identifier within the optical media identification subroutine, the identified text may be sent directly to the comparison subroutine. In embodiments that do not include an optical media identification subroutine, the identified text can be sent directly to the comparison subroutine without verification against database 410 of possible media types.

Magnetic media reader 412 can be communicatively coupled to the processing unit and memory. The processing unit can be configured to execute various software routines. After media 102 is passed through magnetic media reader 412, media 102 may be processed by a magnetic data reading routine 450. In one embodiment, magnetic data reading routine 450 can include a decoding subroutine that decodes and/or reads the encoded magnetic strip data at block 414. Such data may include, for example, an origin of media 102, a beginning location of a trip, a final destination of the trip, a fare or class level associated with media 102, a price of media 102, and the like. In some embodiments the data may also include information related to a period of validity associated with media 102, a balance remaining on media 102, and/or a number of trips remaining on media 102. The decoded data may then be passed to a magnetic media identification subroutine.

The magnetic media identification subroutine can check the data read from media 102 against database 410 of known media types and/or details at block 416. The checking of data against database 410 at block 416 can be performed as described above with regard to block 408 that checks the text against database 410. A single database 410 can be used in comparisons involving both the printed text and decoded data, or separate databases may be used for the printed text and the decoded data.

Both optical imaging routine 440 and magnetic data reading routine 450 can determine if some or all of information is missing in a particular data field. The data fields can be populated with information such as origin of media 102, beginning location of a trip, final destination of the trip, the fare or class level associated with media 102, the price of media 102, and the like. Alternative data fields may be implemented to meet specific needs of a particular user. If information is missing from one or more data fields, optical imaging routine 440 and magnetic data reading routine 450 can mark the fields as unidentifiable in some manner. For example, a data field could be labeled as unidentifiable by leaving a blank entry, inserting a field code, or inserting a pre-determined text entry, such as the word “unidentifiable.”

The comparison subroutine can receive two datastreams, the printed text and the decoded data. The datastreams are then analyzed to see whether the media information and/or media types correspond at block 418. For instance, the printed text may indicate that media 102 is for a trip from Station A to Station B while the decoded data may indicate that media 102 is for a trip from Station A to Station C. In embodiments including one or both of the optical media identification subroutine and the magnetic media identification subroutine, identifiers transmitted to the comparison subroutine can be compared. For example, the optical media identification subroutine may transmit a numeric code 42, which represents the trip from Station A to Station B. The magnetic media identification subroutine may transmit a numeric code 53, which represents the trip from Station A to Station C. In situations where the identifier for the printed text and the identifier for the decoded data match, media 102 can be deemed valid. These examples are merely listed as representations of some possible scenarios, but are not meant to be an exhaustive list of possible scenarios involving data, identifiers, and matches.

After the comparison subroutine determines a degree of correlation between the printed text and the decoded data, the analysis is sent to a course of action subroutine. The course of action subroutine polls a database 420 of business rules and applies the business rules against the results of the analysis. By applying the business rules to the results, a status of media 102 can be determined. Statuses can include, for example, valid, physically damaged, magnetically damaged, poorly encoded, fraudulent, and the like. The course of action subroutine can create a preferred course of action for how media 102 should be handled based on the determined status of media 102 at block 422. The preferred course of action may be sent to an attended or unattended media dispensing location at block 424. Courses of action may include, for example, rewriting media 102, reissuing media 102, confiscation of media 102, issuing new media 102, and the like. The determination of status of media 102 and of the preferred course of action may be performed by the same or by different subroutines.

In embodiments utilizing an attended media dispensing location, the preferred course of action may be displayed to an attendant or clerk at block 426. The attendant may then act in response to the preferred course of action. In some cases, the attendant may be able to override the preferred course of action based on the attendant's judgment concerning any special circumstances related to media 102 and/or authentication module 100. In embodiments involving an unattended media dispensing location, such as the vending machine in FIGS. 2 and 3, the preferred course of action may be sent to a main process controller of the vending machine at block 424. The preferred course of action may be automatically implemented by the main process controller. The automatic implementation could involve having a feeder in the vending machine return or confiscate media 102. In some embodiments, the vending machine is configured to include an encoder and/or writer. In these embodiments, the automatic implementation can further cause the vending machine to re-encode and reissue media 102, or optionally, encode new a media to replace original media 102.

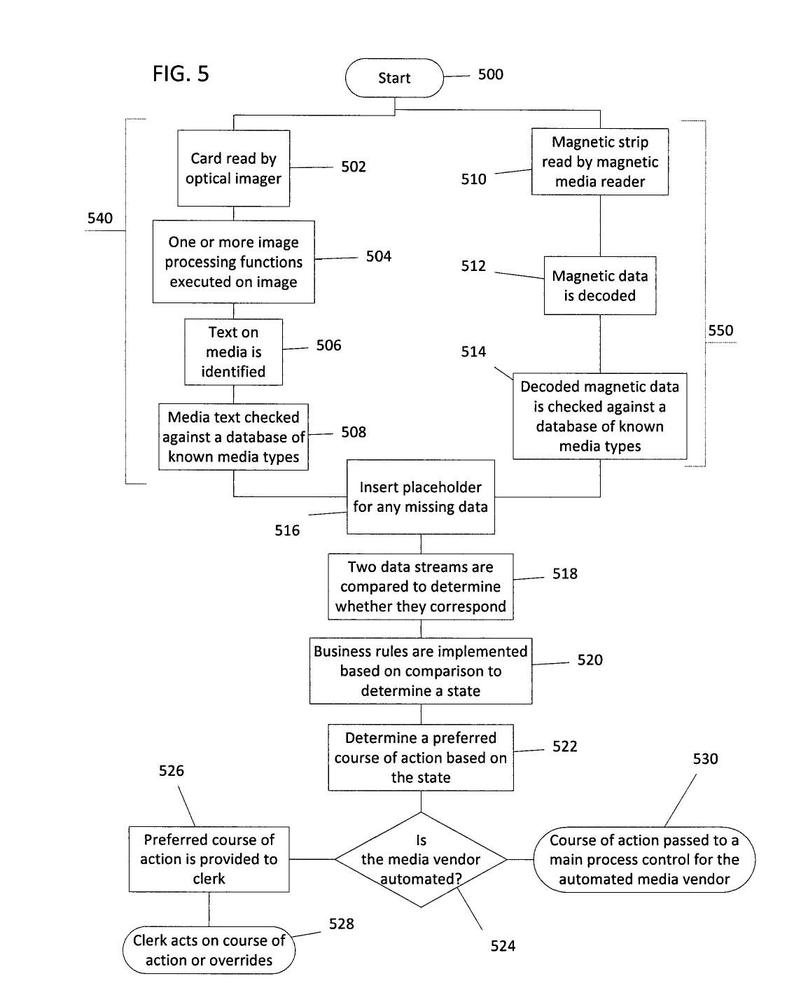

Referring to FIG. 5, a flow chart of an embodiment of a process for authenticating information stored on a magnetic media is shown. The process below may be carried out by authentication module 100 as described in FIGS. 1-4 and/or a separate processing unit and may be embodied in one or more software routines and/or subroutines as described with regard to FIG. 4. In some embodiments, some processes may be consolidated into a single routine or separated into different subroutines. The depicted portion of the process begins in block 500 and completes at one of two endpoints at blocks 524 and 526. The process includes a magnetic strip reading function 550, which can include any combination of blocks 510, 512, and 514. The process can also include an optical imaging function 540, which can include any combination of blocks 502, 504, 506, and 508. An image of the media may be generated by an optical imager at block 502. One or more image processing functions may be executed on the image at block 504. Such image processing functions can be used to sharpen or otherwise enhance the appearance of the image. At block 506, printed text on the image can be identified. In some embodiments, only printed text on a front face and/or a back face of the media will be identified. Printed text on the media can include information regarding the origin of the media, beginning location of a trip, final destination of the trip, the fare or class level associated with the media, the price of the media, and the like. The printed text may optionally be compared to information stored on a media type database at block 508. The media type database may be configured to store information such as station locations and the period of validity for the media. Certain types of identifying information present within the printed text can be checked against the database. If a corresponding entry is found within the database, the database could return an identifier that represents an indexed entry of a particular media type.

The process can also involve reading the encoded magnetic strip data on the media at block 510. The magnetic strip data can be decoded at block 512. In some embodiments, the reading and decoding steps may be combined. At block 514, the decoded data can be compared to information stored on a media type database. Certain types of identifying information present within the decoded data can be checked against the database. If a corresponding entry is found within the database, the database could return an identifier that represents an indexed entry of a particular media type.

A combination of some or all of the processes within magnetic strip reading function 550 can be performed concurrently with or sequentially in any order with a combination of some or all of the processes within optical imaging function 540. Preferably, the two sets of process blocks are run concurrently to minimize the time necessary to complete the entire authentication process.

Both optical imaging function 540 and magnetic strip reading function 550 can determine if some or all of information is missing in a particular data field. The data fields can be populated with information such as origin of the media, beginning location of a trip, final destination of the trip, the fare or class level associated with the media, the price of the media, and the like. Alternative data fields may be implemented to meet specific needs of a particular user. If information is missing from one or more data fields, optical imaging function 540 and magnetic strip reading function 550 can mark the fields as unidentifiable in some manner. For example, a data field could be labeled as unidentifiable by leaving a blank entry, inserting a field code, or inserting a pre-determined text entry, such as the word “unidentifiable” at block 516.

At block 518, two streams of data, the printed text and the decoded data, can be compared to determine whether the streams of data correspond. In cases where identifiers are assigned for the printed text and the decoded data, the identifiers may be compared at block 518.

A database of business rules can be polled and the business rules may be implemented to determine a status of the media at block 520. Statuses of the media can include, but are not limited to, damaged, valid, poorly encoded, fraudulent, and the like. Based on the status of the media, a preferred course of action can be determined for the media at block 522. At block 524, a determination is made whether a local media vendor is automated or attended by a clerk. At block 526, the preferred course of action can be sent to a user interface of an attended device, such as a video media office or standard media office. There, a clerk may view the preferred course of action on a display device. Some embodiments may include a capability for the clerk to override the preferred course of action if the particular circumstances warrant a different action at block 528. Alternatively, the preferred course of action may be sent to a main process control software routine of an automated device, such as a vending machine at block 530. In such embodiments, the automated device can be configured to automatically perform the preferred course of action.

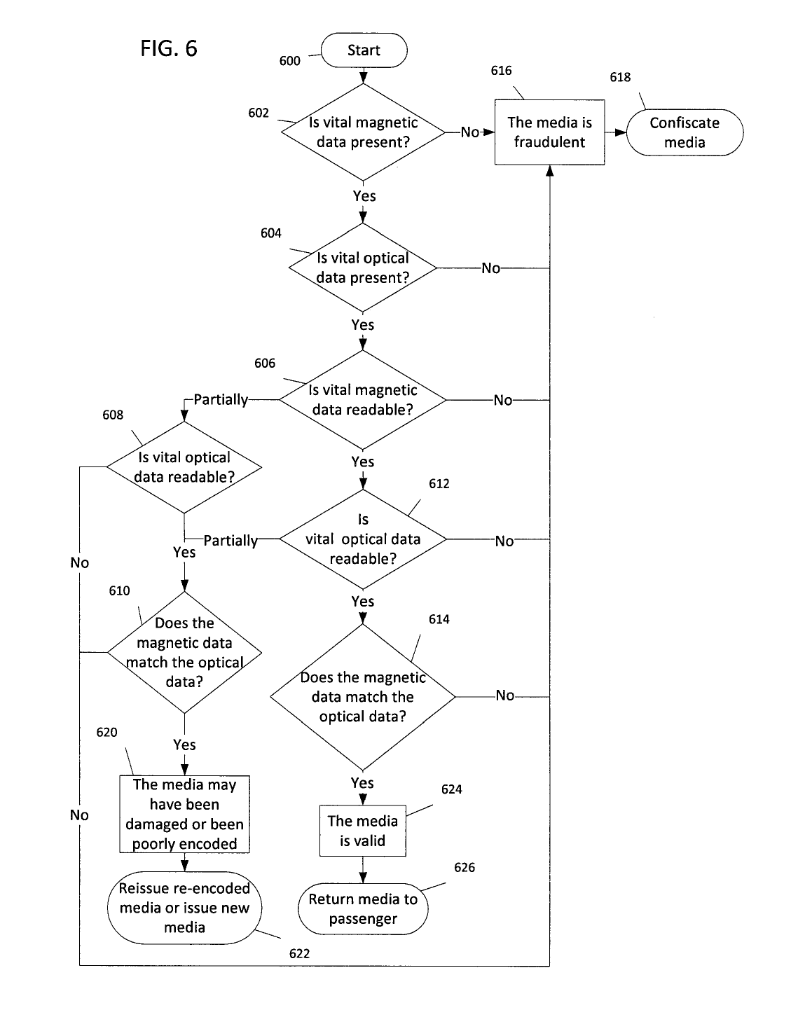

Referring now to FIG. 6, a decision tree illustrating one embodiment of a process for determining possible statuses of a media based on the implementation of business rules is shown. Such decision making for statuses and courses of action may be carried out by authentication module 100 as described above. The status determination described below may be carried out, for example, as described above in blocks 422 and 518 of FIGS. 4 and 5. The determination of courses of action may be completed, for example, in blocks 422 and 520 of FIGS. 4 and 5. Business rules are customizable based on the specific demands of the end user. The process shown in the decision tree is merely offered as an example of how to derive possible statuses and courses of action, and is not meant to represent an exhaustive list of business rule implementations. The process begins at start block 600. Blocks 616, 620, and 624 can represent a status of the media based on the implementation of the business rules as described in reference to the previous figures. The process termination blocks 618, 622, and 626 can represent preferred courses of action based on the status of the media as described in reference to the previous figures. At block 602 a determination of whether important data is present on a magnetic strip of a media is made. Important magnetic data can include any information that is necessary or helpful in determining the nature of the data stored on the media, such as, but not limited to, an origin of the media, a beginning location of a trip, a final destination of the trip, a fare or class level associated with the media, a price of the media, a trip identifier, a monetary or trip balance remaining on the media, and the like. Important magnetic data may be identified by the end user who can ensure that the important data is encoded on the media in a specific and/or indexed location. Other embodiments may assign a priority code to each indexed location to indicate an importance of a particular piece of information stored in the data.

If important magnetic data is missing, the business rules may indicate that the media should be treated as fraudulent at block 616. In some embodiments, fraudulent media may be confiscated at block 618, thus terminating the process. In one embodiment, the confiscation of media involves communication with the passenger regarding the confiscation, reasons for the confiscation, and any possible follow up actions that can be taken by the passenger to contest the confiscation. This communication may be done via human interaction, automated audio, and/or automated video and/or text communication means.

In instances where the media is confiscated or removed, the authentication module may include a database in which information regarding details about the confiscation of the invalid media is stored. Information stored on the database may include such details as the location of the confiscation, the reason for the confiscation (i.e. was the media damaged, fraudulent, etc.), and what was read on the media, such as the origin and/or destination listed on the media, the price of the media or how much fare remains on the media, and the like. The information stored in the database can be used by the end user for tracking purposes. For example, the information could be used to indicate a particular media type or feature was more susceptible to fraudulent activity. Some embodiments could associate an identifier with a particular authentication module, such as authentication module 100 that is carrying out this process and include the authentication module identifier with the information sent to the database. This identifier would allow the particular authentication module 100 to be correlated with the information to help a user determine if a particular authentication module 100 and/or location was having more prevalent fraudulent media redemption attempts.

In some cases, the database may be utilized in handling customer complaints. If a customer disputes a confiscation of a media at any point, an attendant or other end user of the authentication module 100 could access the database to determine a cause of confiscation, as well as information such as the location of the confiscated media. Access to other information could allow for refunds or exchanges to remedy any complaints by a customer that are justified, or when interacting with an unreasonable customer. For instance, if the stored information indicates that the confiscated media was encoded or printed with a particular trip, a refund of the value of the trip or a new media for a new or the same trip could be issued to compensate the customer. The stored location of the confiscated media is useful when a customer disputes the cause of confiscation and a second authentication, either by authentication module 100, another device, or by human inspection can be conducted to verify the course of action taken.

If the important magnetic data is present and no confiscation is necessary, the process can move to a determination of whether important data is present in the printed text of the media at block 604. Important text data can include any data that is necessary or helpful in determining the nature of the information stored on the media, such as, but not limited to, an origin of the media, a beginning location of a trip, a final destination of the trip, a fare or class level associated with the media, a price of the media, a trip identifier, and the like. Important text data may be identified by the end user who can ensure that the important text data is printed on the media in a specific location.

If the important text data is not present, the media may be deemed fraudulent at block 616. The media may be confiscated at block 618. In the case where the important printed text data is present, the process can move to a determination of whether the important magnetic data is readable at block 606. In the case where the important magnetic data is not readable, the business rules may treat the media as being fraudulent at block 616. The media may be confiscated at block 618. In the case where the magnetic data is partially readable, a determination of whether the important printed text is readable at block 608. If the important magnetic data is partially readable and the important printed text is not readable, then the business rules may indicate that the media is fraudulent at block 616. The media may then be confiscated at block 618.

Some end users' needs may require them to place particular emphasis on the presence of one or the other types of data. For example, some end users may feel that the image text is more easily counterfeited, copied, or forged than the magnetic strip data, and therefore, place additional emphasis on the presence of the more secure magnetic data. Other end users may place equal weight on the two types of data and may require at least a portion of each data type to be present in order to honor a media. Some end users may utilize only the magnetic data if the magnetic data is readable. In this case, once the magnetic data is determined to be useable, the data is presumed valid.

In the case where the important magnetic data is partially readable and the important printed text is readable, the information contained in the magnetic data and printed text may be compared at block 610. If the information within the magnetic data does not correspond with the information in the printed text, the business rules may indicate that the media is fraudulent at block 616. The media may then be confiscated at block 618. If the information within the magnetic data does correspond with the information in the printed text, the business rules may indicate that the media may have been damaged or poorly encoded at block 620. In such situations, the media may be re-encoded, reissued, a new media could be issued to a passenger, and/or the customer may receive a refund for all or part of the value of the contents stored on the media at block 622. In other words, when the magnetic data is partially readable and matches the printed text, the decision making routine can determine that the media is damaged and that a new media should be printed and/or encoded for the passenger.

If the important magnetic data is readable, a determination of whether the important printed text is readable can be made at block 612. In some cases, the important magnetic data may be readable but the important printed text may be unreadable. Because there is no way to verify that any of the important magnetic data is valid for the particular media, the business rules may indicate that the media is fraudulent at block 616. The fraudulent media may then be confiscated at block 618. In other embodiments, the important magnetic data may be readable but the important printed text may be only partially readable. In this case, it can be determined whether information within the important magnetic data and information within the partially readable printed text correspond at block 610. If the two sets of information do not correspond, the business rules may indicate that the media is fraudulent at block 616. The media may then be confiscated at block 618. If the information within the data does correspond with the information in the text, the business rules may indicate that the media may have been damaged or poorly encoded at block 620. In such situations, the media may be re-encoded, reissued, a new media could be issued to a passenger, and/or the customer may receive a refund for all or part of the value of the contents stored on the media at block 622.

In some cases, both the important magnetic data and the important printed text will be readable. In this situation, a determination of whether information within the important magnetic data and information within the readable printed text correspond can be made at block 614. If the two sets of information do not correspond, the business rules may indicate that the media is fraudulent at block 616. The media may then be confiscated at block 618. If the information within the data does correspond with the information in the text, the business rules may indicate that the media is valid at block 624. Valid media may be returned to the passenger at block 626. In other words, when the magnetic data is fully readable and matches the image text, the decision making routine can determine that the media is fine and should be returned to the passenger. At a customer's request, a new or re-written media may be issued in lieu of returning the original media at block 626.

The process could also involve steps of verifying the read magnetic data and printed text against a database of known media types to add additional authentication means to the process. Certain types of identifying information present within the important printed text and/or the important magnetic data can be checked against the database. If a corresponding entry is found within the database, the database could return an identifier that represents an indexed entry of a particular media type. In such a case, identifiers representing media types that correspond with the important printed text and the important magnetic data may be compared at block 610 or 614.

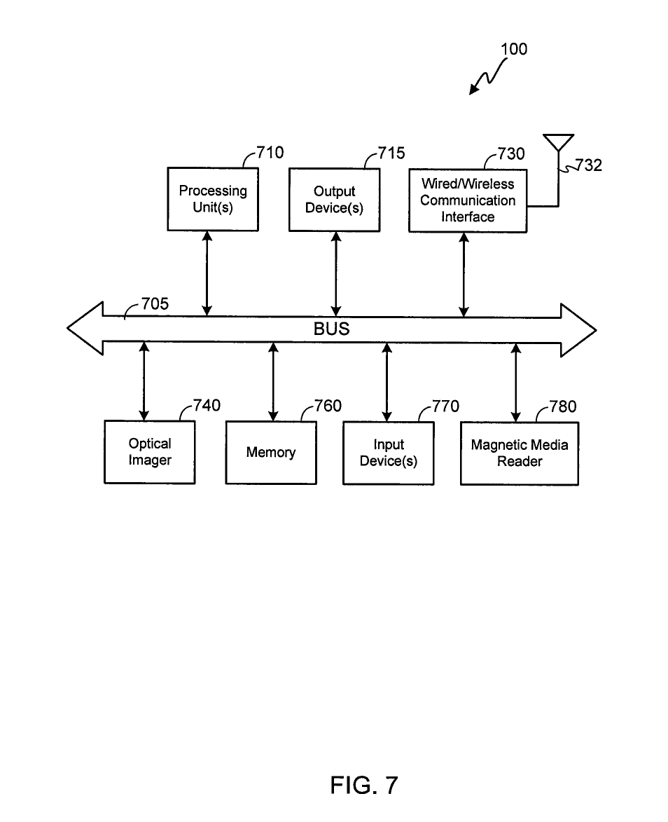

FIG. 7 illustrates an embodiment of a media authentication module 100, which can include an optical imager 740 and a magnetic data reader 780. Authentication module 100 can utilize any combination of software and/or hardware to provide image capture and processing, image display, wireless communication, and/or other functionality as described above. It should be noted that FIG. 7 is meant only to provide a generalized illustration of various components, any or all of which may be utilized as appropriate. Moreover, authentication module elements may be implemented in a relatively separated or relatively more integrated manner.

Authentication module 100 is shown comprising hardware and/or software elements that can be electrically coupled via a bus 705, or may otherwise be in communication, as appropriate. The software elements may include any routine, subroutine, method, decision, or process referenced herein with regards to FIGS. 1-6. The hardware elements may include a processing unit(s) 710 which can include without limitation one or more general-purpose processors, one or more special-purpose processors (such as digital signal processors (DSPs), graphics acceleration processors, application specific integrated circuits (ASICs), and/or the like), and/or other processing structure or means, which can be configured to perform one or more of the methods or to execute one or more of the software routines and/or subroutines described herein. Authentication module 100 also can include one or more input devices 770, which can include without limitation a touch screen, a touch pad, microphone, button(s), dial(s), switch(es), and/or the like; and one or more output devices 715, which can include without limitation a display, light emitting diode (LED), speakers, and/or the like.

Authentication module 100 might also include a wired and/or wireless communication interface 730, which can include without limitation: a modem, a network card, an infrared communication device, a wireless communication device, and/or a chipset (such as a Bluetooth™ device, an IEEE 502.11 device, an IEEE 502.15.4 device, an IEEE 802.3 device, a WiFi device, a WiMax device, cellular communication facilities, etc.), and/or the like. The communication interface 730 may permit data to be exchanged with a network and/or any other electronic devices described herein, such as the pre-existing unit 212 of FIG. 2 and/or vending machine 312 of FIG. 3. Wireless communication can be carried out via one or more wireless communication antenna(s) 732 that send and/or receive wireless signals.

Authentication module 100 may further include and/or be in communication with a memory 760. The memory 760 can include, without limitation, local and/or network accessible storage, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data structures, such as one or more local databases as described herein, and may be allocated by hardware and/or software elements of authentication module 100. Additionally or alternatively, data structures described herein can be implemented by a cache or other local memory of the processing unit(s) 710.

The memory 760 of authentication module 100 also can comprise software elements (not shown), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures and/or features described above might be implemented as code and/or instructions executable by authentication module 100 (and/or the processing unit(s) 710 of authentication module 100) and/or stored on a non-transitory and/or machine-readable storage medium (e.g., a “computer-readable storage medium,” a “process-readable storage medium, etc.). In an aspect, then, such code and/or instructions can be used to configure and/or adapt a general purpose processor (or other device) to perform one or more operations in accordance with the described methods.

The techniques described herein may be implemented by various means. For example, these techniques may be implemented in hardware, software, or a combination thereof. For a hardware implementation, the processing unit(s) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. One or more components of FIGS. 1-7 may be implemented by and/or incorporated into a computer.

For a software implementation, the techniques, processes and functions described herein may be implemented with modules (e.g., procedures, functions, and so on) that perform the functions described herein. The software codes may be stored in memory units and executed by processing units. The memory unit may be implemented within the processor or external to the processor, in which case it can be communicatively coupled to the processing unit via various means as is known in the art.

While the principles of the disclosure have been described above in connection with specific apparatuses and methods, it is to be clearly understood that this description is made only by way of example and not as limitation on the scope of the disclosure.

What is claimed is:

1. A method for determining a status of a transit media, the method comprising:
imaging a transit media with an optical imager to create a digital image of one or more surfaces of the transit media;
generating optical data from the digital image, wherein the optical data comprises information indicative of a transit product or usage;
obtaining magnetic data from a magnetic strip of the transit media with a magnetic media reader, wherein the magnetic data comprises information indicative of the transit product or usage encoded within the magnetic strip;
comparing, using a processing unit, the optical data with the magnetic data to determine whether the optical data corresponds with the magnetic data; and
implementing one or more business rules from a database of business rules to determine a status of the transit media, wherein the implementation is based on the comparison.

2. The method for determining a status of a transit media as in claim 1, wherein the method further comprises a step of comparing either or both of the optical data or the magnetic data to known media types stored in a database to verify that either or both of the optical data or the magnetic data correspond to the known media types.

3. The method for determining a status of a transit media as in claim 1, wherein the method further comprises executing one or more image processing functions on the digital image.

4. The method for determining a status of a transit media as in claim 1, wherein the optical data comprises printed text on one or more surfaces of the transit media that is identified with optical character recognition.

5. The method for determining a status of a transit media as in claim 1, wherein the status of the transit media comprises at least one of the following: valid, poorly encoded, magnetically damaged, physically damaged, or fraudulently created.

6. The method for determining a status of a transit media as in claim 1, wherein the method further comprises determining a course of action based on the status of the transit media.

7. The method for authenticating a status of a transit media as in claim 6, wherein the course of action comprises at least one of the following: confiscating the transit media, reissuing the transit media, or returning the transit media.

8. The method for determining a status of a transit media as in claim 1, wherein the method further comprises confiscating a fraudulently created transit media using a feeder communicatively coupled with the processor and storing a date of the confiscation and information associated with the confiscation in a database.

9. The method for determining a status of a transit media as in claim 1, wherein the comparison comprises a degree that the optical data and the magnetic data correspond.

10. The method for determining a status of a transit media as in claim 1, wherein the method further comprises identifying missing optical data or magnetic data, and wherein a placeholder is inserted to mark the missing optical data or missing magnetic data.

11. A system for determining a status of a transit media, the system comprising:
an optical imager configured to receive a transit media and produce a digital image of one or more surfaces of the transit media;
a magnetic media reader configured to obtain magnetic data from a magnetic strip of the transit media to identify information encoded within the magnetic strip, wherein the magnetic data comprises details relating to a transaction history or transit history of the transit media within a transit system details relating to a transaction history or transit history of the transit media within a transit system; and
a processing unit communicatively coupled with the optical imager and the magnetic media reader, wherein the processing unit is operable to:
identify printed text on the digital image,
compare the magnetic data and the printed text to determine whether information store in the magnetic data and the printed text correspond, and
implement one or more business rules from a database of business rules based on a degree that the optical data and the magnetic data correspond to determine a status of the transit media; and
determine a course of action based on the status of the transit media.

12. A system for determining a status of a transit media as in claim 11, wherein the processing unit is further operable to execute one or more image processing functions on the digital image.

13. A system for determining a status of a transit media as in claim 11, wherein the processing unit is further operable to compare either or both of the printed text or the magnetic data with known media types stored in a database to verify that either or both of the printed text or the magnetic data correspond to the known media types.

14. A system for determining a status of a transit media as in claim 11, wherein the system further includes a feeder communicatively coupled to the processor, wherein the processor can send a command to the feeder to confiscate the transit media.

15. A system for determining a status of a transit media as in claim 11, wherein the processing unit is further operable to identify missing printed text or magnetic data, and insert a placeholder to mark the missing printed text or missing magnetic data.

16. A computer program embodied on a computer-readable medium, the computer program comprising instructions executable by a computer to:
generate optical data from a digital image of one or more surfaces of a transit media, wherein the optical data comprises information that identifies details relating to a transaction history or transit history of the transit media within a transit system;
compare the optical data with magnetic data that is encoded on a magnetic strip of the transit media to determine whether the optical data corresponds with the magnetic data; and
implement one or more business rules based on the comparison of the optical data and the magnetic data to determine a status of the transit media; and
determine a course of action based on the status of the transit media.

17. A computer program embodied on a computer-readable medium as in claim 16, wherein the computer program further comprises instructions executable by a computer to execute one or more image processing functions on the digital image.

18. A computer program embodied on a computer-readable medium as in claim 16, wherein the computer program further comprises instructions executable by a computer to compare either or both of the optical data or the magnetic data with known media types stored in a database to verify that either or both of the optical data or the magnetic data correspond to the known media types.

19. A computer program embodied on a computer-readable medium as in claim 16, wherein the computer program further comprises instructions executable by a computer to identify missing optical data or magnetic data, and insert a placeholder to mark the missing optical data or missing magnetic data.

20. A computer program embodied on a computer-readable medium as in claim 16, wherein the computer program further comprises instructions executable by a computer to initiate a confiscation request for a fraudulently created transit media and to store a date of the confiscation and information associated with the confiscation in a database.
